(19) United States
(12) Patent Application Publication
(10) Pub. No.: US 2007/0054022 A1
(43) Pub. Date: Mar. 8, 2007

(54) Method for the production of a sweetener salt based on aspartame and acesulfame

(76) Inventors: Peter Groer, Bad Soden (DE); Gerhard Merkt, Frankfurt (DE)

Correspondence Address: PROPAT, L.L.C., 425-C SOUTH SHARON AMITY ROAD, CHARLOTTE, NC, 28211-2841, US

(21) Appl. No.: 10/563,155

(22) PCT Filed: Jun. 26, 2004
(86) PCT No.: PCT/EP04/06957

§ 371 Date: May 18, 2006

(30) Foreign Application Priority Data
Jul. 3, 2003 (DE) 103 30 025.2

(51) Int. Cl. A23L 1/236

(52) U.S. Cl. 426/548

(57) ABSTRACT

This invention relates to a method for producing a sweetener salt of formula APMH⁺Ace⁻, according to which aspartame or an aspartame derivative is reacted with acesulfamic acid in a solvent selected among one or several of the following: liquid SO₂; halogenated aliphatic hydrocarbons; carbonic acid esters comprising low, aliphatic alcohols; nitroalkanes; alkyl-substituted pyridines; and aliphatic sulfones. The invention also relates to the use of said sweetener salts in food, beverages, pharmaceuticals, and cosmetics.

The present invention relates to a non-calorific sweetener consisting of acesulfame and aspartame or a derivative of aspartame such as neotame or alitame, its production and use, especially in foods, beverages, pharmaceuticals and cosmetics.

This sweetener is produced by adding aspartame or its derivatives during the production process of acesulfame. This can be done directly in the process solvent being used without any special temperature settings and without the addition of acid or the use of other solvents during the in-situ production of acesulfamic acid.

The use of acesulfamic acid for the production of a sweetener salt containing aspartame or aspartame derivatives is described in ES-A-8604766. In this case, solid acesulfamic acid is first dissolved in methanol, whereby no information is provided regarding the source or the production of the isolated acesulfamic acid used. In a subsequent step, the use of at least one additional solvent is described.

U.S. Pat. No. 5,827,562 specifies why during the process according to ES-A-8604766 a salt is obtained which is not very satisfactory qualitatively. It is characterized especially by a relatively high moisture content and very little thermal stability. Furthermore, handling the thermally instable sweetening acid acesulfamic acid in isolated form is technically difficult.

Hence, U.S. Pat. No. 5,827,562 discloses an alternative process which is characterized in that, instead of the instable sweetening acid acesulfamic acid, its salts, e.g. the potassium salt (acesulfame-K), is present and reacts together with aspartame and a strong acid in an aqueous solution. What can be obtained as a product is a crystalline salt for further use as a highly intensive sweetener.

The disadvantage of this process is that the addition of the strong acid adds process engineering complexities to the production and the complex process leads to high production costs. Furthermore, the potassium salt formed during the reaction of the reactive components must be removed and disposed of, with the familiar negative ecological and economic consequences.

Hence, the problem of the present invention was to develop a process for which the instability of the sweetening acid acesulfamic acid in isolated form is irrelevant, and that besides the two components acesulfamic acid and aspartame or aspartame derivative as well as a solvent does not require any further reactive components. Hence, the goal was, among other things, to do without a strong acid and an additional solvent. The detour via acesulfame-K, which is known to be obtained from acesulfamic acid, and the unavoidable accumulation of a potassium salt related to this should also be avoided.

This problem is solved by the reaction of aspartame with an acesulfamic acid solution as it accumulates directly during the production of acesulfame-K, for example after what is known as the SO₃ process in EP-A-0 155 634. In solutions of these types the acesulfamic acid is present in solution as an intermediate product in the solvents specified, preferably methyl chloride.

Because of the special general conditions of the process described in EP-A-0 155 634 only inert inorganic or organic solvents are available which can be used individually or in a mixture.

Liquid SO₂ is available as an inorganic solvent. The available organic solvents are:
halogenated aliphatic hydrocarbons, preferably with as many as 4 C atoms such as methyl chloride, chloroform, ethylene dichloride, trichloroethylene, tetrachloroethylene, trichloromonofluoroethylene, etc.;
carbonates with low, i.e. C1-C4, aliphatic alcohols, preferably with methanol, ethanol, ethylene glycol, or 1,3-propylene glycol;
nitroalkanes, preferably with up to 4 C atoms, especially nitromethane;
alkyl disubstituted pyridine, preferably collidine;
aliphatic sulfones

The acesulfamic acid formed in the solvent reacts during the addition of aspartame or an aspartame derivative surprisingly directly to form a stable precipitate which consists of the salt of the two components aspartame or aspartame derivative and acesulfamic acid. In the sweetening salt formed, the stoichiometric ratio of the acesulfame anion and the aspartame cation or the cation of the aspartame derivative is 1:1; it is designated APMH⁺Ace⁻.

Aspartame or its derivatives can be added in a pure form, for example as a solid or in an appropriate solvent as a solution or a suspension to the acesulfamic acid solution. The addition can also occurred in the reverse sequence.

What is understood here by aspartame derivatives such as are described in DE 36 12 344 A1 or U.S. Pat. No. 4,826,824, are neotame and alitame or the structural modifications based on aspartame, neotame and alitame.

The concentration of acesulfamic acid in the reactive solution is between 0.3 wt. % and 50 wt. %, preferably between 1 wt. % and 10 wt. % and especially preferably between 1.5 wt. % and 5 wt. %. The maximum forms the saturation limit of acesulfamic acid in the individual solvent, observing the dependence on temperature.

Assuming, for the performance of the process according to the invention, the SO₃ process according to EP-A-0 155 634, the acesulfamic acid solution, obtained as a reaction intermediate during acesulfame-K production prior to the reaction with aspartame or its derivatives, can be further diluted or concentrated. This is only limited by the economy or solubility of acesulfamic acid in the relevant solvents as well as the manageability of the suspension obtained during the reaction. Concentrations of 0.1 to 5 wt. %, preferably 1 to 5 wt. %, especially preferably from 2 to 3 wt. %, acesulfamic acid have been shown to be suitable; But acesulfamic acid suspensions could of course also be used.

The concentration ratios of the components to each other are not firmly defined. If one wants to obtain the sweetening salt APMH⁺Ace⁻ without the residual amounts of the starting products for this reaction, the components must be present in a stoichiometric ratio of 1:1. If an admixture of the starting components is wanted, the stoichiometric ratios can be varied correspondingly between 0.005:99.995 and 99.995:0,005. The stoichiometrically smaller portion in each case reacts in the process completely into the sweetening salt APMH⁺Ace⁻, while the component with the excess portion is present as a precipitate or completely or partially dissolved.

The chemical reaction occurs in dependence on the melting and boiling point of the solvent used in a temperature range of between −95° C. and 126° C., but preferably at between 0 and 45° C. and especially preferably at room temperature.

The reaction is performed for reasons of economy preferably at atmospheric pressure, but is not limited to it. By modifying the pressure during the reaction the crystallization of the product can be influenced in a manner familiar to a person skilled in the art.

The reaction can be performed in a reaction vessel, non-stirred or stirred or mixed in some other manner. Equally suitable are crystallization devices as are commonly used for crystallization out of solutions.

The precipitated reaction product is mechanically separated from the reaction solution according to familiar processes. finally the product can be further purified by an recrystallization.

A preferred process of the recrystallization is performed by dissolving the reaction product in a mixture of solvent, preferably consisting of a mixture of water and one or several water-soluble, organic solvents. While in pure solvents such as water, ethanol, methanol or acetone, the salt acesulfame aspartame is not or poorly soluble, it was surprisingly found that a recrystallization and purification of the salt is possible using solvent mixtures. Preferred solvents for the mixture are: water, acetone and short-chain, branched or unbranched aliphatic alcohols with one to four carbon atoms.

Preferred solvent mixtures are water/acetone and water/ethanol mixtures, especially preferred is a water/acetone mixture. In the process the reaction product according to the invention is recrystallized in a manner familiar to a person skilled in the art. The dissolving of the salt by means of a suitable stirring device is performed advisably in the temperature range from 35° C. to 100° C., preferably 35° C. to 80° C. and especially 50° C. to 60° C. The upper temperature range is determined by the boiling point of the solvent mixture. The crystallization out [of solution] is caused by lowering the temperature to −35° C. to +30° C., preferably −10° C. to +20° C. and especially 0° C. to +10° C. The lower temperature range is limited by the melting point of the solvent mixture. For a binary solvent mixture consisting of water and another solvent component, the mixture ratio ranges from 10% (v/v):95% (v/v) to 99% (v/v):1% (v/v), preferably from 50% (v/v):50% (v/v) to 97% (v/v):3% (v/v) and especially from 85% (v/v):15% (v/v) to 94% (v/v):6% (v/v).

Alternative to this, the influence of the crystallizing out [of solution] can also be achieved by a shift of the ration of the solvent components to water such as by evaporating the solvent or by the addition of water.

Surprisingly, it was found that for the invention's recrystallization of the salt, depending on the setting of parameters such as temperature, type of solvent, portions of solvent in the mixture, etc. the yield is visibly greater than 85% and as much as 99% and that the purity of the aspartame acesulfamic acid is already greater than 99% after the first recrystallization process.

The recrystallization can be followed by a common drying process known to a person skilled in the art, for example drum drying, fluidized bed drying, etc.

Sweetening salt made according to this process features an especially high degree of purity and stability in comparison with known products. The product features the following characteristics:
1. The stability of the production according to the invention, measured against the concentration of the breakdown product diketopiperazine (DKP) after thermal load, is less than 0.005 wt. %, preferably less than 0.001, especially preferred less than 0.0006 wt. %, if it is heated for 240 min at 120° C., or less than 0.005 wt. %, preferably less than 0.001 wt. %, especially preferred less than 0.0006 wt. %, decomposition (DKP), if it is heated at 130° C. for 60 min.
2. The potassium content is less than 50 ppm, preferably less than 20 ppm, especially preferred less than 1 ppm. Especially preferred is a potassium content of less than 0.5 ppm.

According to the invention, the sweetening salt APMH⁺Ace⁻ is used in foods, beverages and pharmaceuticals, advisably in quantities of 20 to 3000 ppm, preferably in quantities of 100 to 2500 ppm, especially in quantities of 150 to 500 ppm, in each case in relation to the mass of the food, beverage or pharmaceutical to which it is added. For cosmetics, higher concentrations of up to 4,500 ppm can also be used.

The invention is explained in greater detail below with the help of examples.

### EXAMPLES

### Example 1

### 3% Acesulfamic Acid Solution (From the Production According to EP-A-0 155 634 Prior to Neutralization) in CH₂Cl₂

543 ml of a 3% acesulfamic acid solution in CH₂Cl₂ are filled in first in a 1 l glass beaker equipped with a paddle mixer at room temperature. A stoichiometrical equivalent quantity of aspartame (APM) with 29.4 g is added. Within a few minutes a white precipitate appears. This is filtered out and washed with a few ml of ice-cold methyl chloride and dried in a vacuum at 40° C. Obtained are 43.7 g of a white salt (96% of the theoretical value).

The present salt was examined for the presence of the components aspartame (APM) and acesulfamic acid (AceH) using the HPLC process. The stoichiometric value of the components is theoretically 1 or a molecular weight ratio of 1.82 APMH⁺Ace⁻. The average value measured is 1.95.

Taking into account the HPLC measurement precision of 5%, the measurement value covers a an interval of error of 1.76 to 2.16. Accordingly, the theoretically predetermined value of 1.82 is within the range of measurement.

### Examples 2-5

### Variation of the Solvent

### Example 2

### 3% Acesulfamic Acid Solution in Chloroform

Carried out analogously to example 1, methyl chloride was replaced with chloroform. Yield: 87% of the theoretical value. The composition of the salt corresponds to example 1.

### Example 3

### 3% Acesulfamic Acid Solution in Nitromethane

Carried out analogously to example 1, methyl chloride was replaced with nitromethane. Yield: 87% of the theoretical value. The composition of the salt corresponds to example 1.

### Example 4

### 3% Acesulfamic Acid Solution in Diethylcarbonate

Carried out analogously to example 1, methyl chloride was replaced with diethylcarbonate. Yield: 90% of the theoretical value. The composition of the salt corresponds to example 1.

### Example 5

### 3% Acesulfamic Acid Solution in Carbon Tetrachloride

The procedure was carried out analogously to example 1, methyl chloride was replaced with carbon tetrachloride. Yield: 87% of the theoretical value. The composition of the salt corresponds to example 1.

### Examples 6 and 7

### Variation of the Reaction Temperature

### Example 6

Carried out analogously to example 1, but reaction temperature 0° C. Yield: 90% of the theoretical value. The composition of the salt corresponds to example 1.

### Example 7

Carried out analogously to example 1, but reaction temperature 40° C. Yield: 92% of the theoretical value. The composition of the salt corresponds to example 1.

### Examples 8-10

### Various Concentrations of the Acesulfamic Acid Solution

### Example 8

Carried out analogously to example 1, but 0.3% acesulfamic acid solution. Yield: 94% of the theoretical value. The composition of the salt corresponds to example 1.

### Example 9

Carried out analogously to example 1, but 1% acesulfamic acid solution. Yield: 95% of the theoretical value. The composition of the salt corresponds to example 1.

### Example 10

Carried out analogously to example 1, but 9% acesulfamic acid suspension. Yield: 93% of the theoretical value. The composition of the salt corresponds to example 1.

### Example 11

5 g of the crude salt from example 1 were dissolved in 20 ml solvent mixture at a process temperature of between 52° C. and 56° C. and subsequently brought to crystallization at between 3° C. and 8° C.

### Example 11.1

Solvent mixture: ethanol/water 10% (v/v):90% (v/v)

Result:

Yield: 87% of the theoretical value.

Purity: >99%

### Example 11.2

Solvent mixture: acetone/water 10% (v/v):90% (v/v)

Result:

Yield: 93% of the theoretical value.

Purity: >99%

The production and purification process of the acesulfame aspartame sale was designed in such a way that in the process a highly pure substance, consisting of the acesulfamic acid anion and an aspartame cation, is obtained.

This new and special process also influences the physical characteristics of the aspartame acesulfame salt. This salt is characterized in particular by a different stability at high temperatures in dependence on its water content in comparison to the product in U.S. Pat. No. 5,827,562.

With a water content of less than 1 wt. % and larger than 0.5 wt. % and at a temperature input of 120° C. for 1 h duration, the concentration of the breakdown product diketopiperazine is below 0.5 wt. %, especially under 0.2 wt. % in relation to the dry substance.

With a water content of less than 0.5 wt. % and a temperature input of 120° C. for 1 h duration, the concentration of the breakdown product diketopiperazine (DKP) is below 0.1 wt. %, especially below 0.05 wt. %, in relation to the dry substance.

Result of Example 11.1:

Water content: 0.7 wt. %

DKP content (120° C., 4 h): <0.0005 wt. %

DKP content (130° C., 1 h): <0.0005 wt. %

Result of Example 11.2:

Water content: 0.3 wt. %

DKP content (120° C., 4 h): <0.0005 wt. %

DKP content (130° C., 1 h): <0.0005 wt. %

The results show that the salt obtained according to the process described above features a very high degree of stability which is magnitudes greater than the stability which was described for the products according to the prior art (see U.S. Pat. No. 5,827,562).

1. Process for the production of a sweetening salt with an aspartame cation and an acesulfame anion, said process comprising reacting aspartame or an aspartame derivative with acesulfamic acid in a solvent selected from one or several of the following solvents:
liquid SO₂;
halogenated aliphatic hydrocarbons;
carbonate esters with low, aliphatic alcohols;
nitroalkanes;
alkyl disubstituted pyridines; and
aliphatic sulfones.

2. Process according to claim 1, wherein the aspartame derivative is a compound selected from: neotame, alitame, and structural variants of aspartame, neotame and alitame.

3. Process according to claim 1, wherein the concentration of acesulfamic acid in the reactive solution is between 0.3 wt. % and 50 wt. %.

4. Process according to claim 1, wherein the stoichiometric ratio of aspartame or the aspartame derivative to the acesulfamic acid is 1:1.

5. Process according to claim 1, wherein the stoichiometric ratio of aspartame or the aspartame derivative to acesulfamic acid is between 0.005:99.995 and 99.995:0.005.

6. Process according to claim 1, wherein the reaction is carried out in a range of temperature of between −95° C. to +126° C.

7. Process according to claim 1, wherein the sweetening salt is recrystallized.

8. Process according to claim 7, wherein the recrystallization is carried out in a solvent mixture.

9. Process according to claim 7, wherein the solvent mixture contains two or several of the solvents selected from water, acetone and C₁-C₄ alcohol.

10. Process according to claim 7, wherein the solvent mixture consists of water and acetone.

11. Process according to claim 7, wherein the recrystallization is carried out at a temperature of −35° C. to +30° C.

12. Sweetening salt consisting of an aspartame cation and an acesulfame anion, wherein the decomposition of the sweetening salt into diketopiperazine is smaller than 0.005 wt. %, when the salt is heated for 240 min at 120° C., or when the salt is heated at 130° C. for 60 min.

13. Salt according to claim 12, wherein said salt features a potassium content less than 50 ppm.

14. Food, beverages, pharmaceuticals and cosmetics comprising a salt according to claim 12.
